(19) United States
(12) Patent Application Publication
(10) Pub. No.: US 2014/0178839 A1
(43) Pub. Date: Jun. 26, 2014

(54) REMOVABLE DENTAL IMPLANT BRIDGE SYSTEM

(71) Applicant: Uzi Berger, Hod Hasharon (IL)

(72) Inventor: Uzi Berger, Hod Hasharon (IL)

(73) Assignee: KAMIL TECH LTD., Road Town, Tortola (VG)

(21) Appl. No.: 14/238,118

(22) PCT Filed: Aug. 8, 2012
(86) PCT No.: PCT/IL2012/050298

§ 371 Date: Feb. 10, 2014

Related U.S. Application Data
(60) Provisional application No. 61/522,038, filed on Aug. 10, 2011.

(51) Int. Cl. A61C 13/01; A61C 8/00

(52) U.S. Cl. CPC A61C 13/01; A61C 8/0048
USPC 433/173

(57) ABSTRACT

A removable dental implant bridge system configured for rigid detachable mounting of an implant removable bridge over a mini support bar, which in turn is configured for fixedly securing to the jaw bone of an individual, in a fashion facilitating fast and easy mounting yet fixedly supporting the implant removable bridge so as to obtain a sturdy and secure engagement to the mini support bar, and however suited for easy removal, wherein bar is substantially received with a teeth mimicking portion of the implant removable bridge and where the mini support bar is configured with scalloping at least at a labial face and a bottom face thereof.

### FIELD OF THE DISCLOSED SUBJECT MATTER

The presently disclosed subject matter relates to a detachably attachable dental implant bridge system.

### BACKGROUND OF THE DISCLOSED SUBJECT MATTER

Partial or complete loss of an individual's natural teeth, either or both at the upper and lower jaw, due to age, accident, diseases or other reasons, has some serious effects on an individual, both functionally and socially. Lack of teeth poses several serious functional problems such as distortion of the individual's face, not being able to chew, speech difficulties, etc. Even more so, a smile with a full set of white teeth is considered something to be desired, i.e. esthetics play an important role. These problems become more severe depending on the number of missing teeth.

Utilization of artificial denture appliance poses a general problem concerned with retention of same in position as during normal chewing or talking, the appliance may have the tendency to ride up out of its position, causing speech difficulties, chewing difficulties, spitting and other social unpleasant situations, resulting in general unsatisfactory. In addition, it is desired that the alliance be in minimal contact with the individual's gums so as to prevent or reduce to minimum irritation thereof.

A challenge in this field is designing and manufacturing the bridge so as to achieve perfect fitting thereof to the particular needs and anatomical parameters of the individual. Yet, it is required that the bridge be readily and easily be attached within the individuals mouth at a fixed position (i.e. with substantially no movement once placed) and yet easily removable by the individual.

There are known personalized dentures, such as, for example, U.S. Pat. No. 7,806,691 disclosing a removable denture system comprising a support beam fixedly attached to the individual's alveolar ridge above the mucous membrane by a plurality of dental implants, and a denture generally conforming with the dental parameters of the individual and integrated with a super-structure. The super-structure comprises at least a portion shaped in confirmation with the support beam, and a denture locking arrangement for removably though fixedly articulating the denture to the support beam preventing unintentional disengagement of the denture.

Dental bridges are known to be fixedly attached to implants by means of connecting elements, referred to as ‘abutments’, or by direct fixing thereof to the implants. An abutment is usually fastened to the implant at its one end, and to a bridge or another element at its other end. In the installed state the abutments are usually invisible or visible to a limited degree in the patient's mouth.

U.S. Pat. No. 4,767,328 discloses a device for securing a plurality of teeth to at least two attachment elements implanted in the alveolar bone; said device comprising an essentially rigid splint, preferably of titanium or titanium alloy, and assembly means for removably fastening a row of teeth to said splint, the splint being arranged at least between said attachment elements to absorb and distribute the load arising upon use.

### SUMMARY OF THE DISCLOSURE

According to the disclosed subject matter there is provided a removable dental implant bridge system configured for fixedly yet detachable anchorage of an implant removable bridge (IRB) over a mini support bar (MSB), which in turn is secured over the jaw bone, in a fashion facilitating fast and easy mounting yet fixedly supporting the implant removable bridge (IRB) so as to obtain a sturdy and secure engagement to the mini support bar, and however configured for easy and readily removal thereof.

The term ‘implant removable bridge’ (IRB) (often simply referred to as ‘bridge’) as used herein the specification and claims denotes an integrated array of artificial teeth mimicking the teeth of an individual and designed for anchoring over a mini support bar fixed to the individual's jaw bone (mandibular or maxillar), substantially without a skirt portion, i.e. a gum mimicking portion (at times referred to as an ‘acrylic flange’ or ‘buccal flange’).

It is however appreciated that a substantially narrow transition zone can extend, for improved aesthetics and to prevent speech/phonetic distortion. Such a strip is hereby defined as a scalloping gingival strip (SGS) and it mimics and merges with the individual's buccal gingival area in appearance and shape, i.e. as far as its scalloping shape, color and stippling thereof.

The term ‘mimicking’ suggests that the implant removable bridge (IRB) and scalloping gingival strip (SGS), where relevant, follows the individual's anatomical parameters, such as shape, texture, size, color etc.

The removable dental implant bridge system is detachably attached to the mini support bar, which in turn is secured to a plurality of fixtures fixed to the jawbone (directly or indirectly through abutments).

The term ‘fixture’ as used herein throughout the specification and claims denotes studs and implants (used interchangeably) fixedly secured within the respective jaw bone. It is appreciated that any form of fixture can be used, such as, subperiostal implants, blade fixtures, and the like. A ‘head portion’ projects through the gum and directly bears the mini support bar (i.e. using a one-piece implant, wherein the fixture is integrated with an abutment portion projecting above the gum), or indirectly, i.e. said head portion is an abutment secured over a head of the fixture.

The term ‘crown portion’ as used herein the specification and claims denotes a body portion of the teeth (the teeth mimicking portion), i.e. a visible portion of the teeth extending above the gum line, mimicking the normally visible natural enamel portion of a tooth, extending above the gum line of an individual.

The bridge system according to the disclosed subject matter comprises:
a plurality of fixtures for securing to a jaw bone, with a head portion projecting from the gum;
a mini support bar (MSB) for fixedly securing over the head portions; said mini support bar sized for fitting within the crown portion of an implant removable bridge (IRB);
an implant removable bridge (IRB) generally conforming with dental parameters of the individual, configured at a bottom surface thereof with a super structure fully extending within a crown portion of the IRB, said super structure shaped and configured so as to snugly fit, at high tolerance, over at least portions of the mini support bar (MSB).

According to another aspect of the present disclosed subject matter there is provided an implant removable bridge (IRB) generally conforming with dental parameters of the individual, with a crown portion having a bottom surface configured with a super structure fully extending within the IRB, said super structure shaped and configured so as to snugly fit, at high tolerance, over at least portions of a mini support bar (MSB) fixedly secured to a jawbone, however configured for easy and readily removal.

According to yet another aspect of the present disclosed subject matter there is provided a mini support bar (MSB) for fixedly securing to a jaw bone of an individual directly over fixtures or indirectly over abetments, said mini support bar shaped and configured for snugly fit, at high tolerance, over at least portions thereof within a super structure and fully extending within a crown portion of an implant removable bridge (IRB).

This structure renders the bridge system suitable in particular, though not restricted, to individuals with a petit structure, i.e. small face, small mouth, small teeth and individuals not experiencing jaw-bone loss;

The present disclosed subject matter further calls for a method for applying an individual with an implant removable bridge (IRB) at a readily removably yet secured fashion, the method comprises the following steps:
fixing several fixtures into a jawbone of the individual, each having an implant body fixedly received within the jawbone and a head portion projecting from the gum;
obtaining a mini support bar (MSB) sized for fitting within the crown portion of an implant removable bridge (IRB);
fixing the mini support bar over the head portion of the fixtures or over abutments secured to the fixtures;
obtaining an implant removable bridge (IRB) generally conforming with dental parameters of the individual, having a bottom surface with a receiving aperture configured with a super structure fully extending within a crown portion of the implant removable bridge IRB, said super structure shaped and configured so as to snugly fit, at high tolerance, over the mini support bar (MSB).
placing the implant removable bridge (IRB) over the mini support bar such that the super structure snugly bears, at high tolerance over at least portions of the mini support bar.

The method may further comprise the steps of locking/unlocking the implant removable bridge (IRB) over the mini support bar in position by virtue of one or more locking arrangements.

It is noted that the super structure fully extends within the implant removable bridge (IRB), i.e. fully extends within the crown portion, and can be fixedly embedded within the implant removable bridge (IRB), namely be an element of material applied within the implant removable bridge and integrated therein at a fixed fashion. Alternatively, the super structure is a receiving aperture extending and formed within the bottom face of the implant removable bridge (IRB), born out of the implant removable bridge.

Any one or more of the following features and designs can be applied to the bridge system or to any one of the other aspects subject of the present application, independently or in combination:
A locking arrangement is provided for removably locking the implant removable bridge (IRB) to said mini support bar (MSB), and comprising one or more locks for detachable locking of the implant removable bridge (IRB) to the mini support bar (MSB). The locks can be of any one or more types.
The tolerance between the super structure of the implant removable bridge (IRB) and the mini support bar is tight, at least at several positioning locations, so as to reduce, or substantially eliminate any tolerance and respective motion/movement therebetween. However, removal of the implant removable bridge (IRB) is facilitated substantially without the need of any tools, along the path of insertion and substantially without the need to apply any excessive force. According to other examples, tolerance between the super structure and the mini support bar is tight substantially along their entire lengths;
Positioning locations are disposed along the mini support bar at locations corresponding with fixture arresting sites;
The mini support bar (MSB) has widened portions at the positioning locations;
The mini support bar is elevated from the gum, at least along portions thereof, giving rise to a gap between the gum and a bottom surface of the mini support bar;
The positioning locations are configured to extend at corresponding crown portions of the implant removable bridge (IRB) (rather than at a portion between teeth);
The mini support bar (MSB) is shaped in reduced scale of the implant removable bridge (IRB);
The mini support bar (MSB) is configured with at least a scalloping labial surface and a scalloping bottom surface at least at a labial side thereof;
The super structure within a crown portion of the implant removable bridge (IRB) is configured with widened locations at location corresponding with the positioning locations of the mini support bar, said positioning locations extending at a teeth portions of the implant removable bridge (IRB) (rather than at a portion between teeth);
The mini support bar can be configured with a plurality of positioning locations, wherein neighboring positioning locations are connected by integral beams, said beams being of reduced size; the implant removable bridge (IRB) is configured for tight tolerance with the at least positioning locations of the mini support bar;
The mini support bar (MSB) is made of any rigid, metallic or non-metallic material (such as, for example, metals—gold, titanium, chrome-cobalt, different forms of zirconium, porcelain, plastic/acrylic/polymeric materials, composite materials, and combinations thereof, glass and carbon, and/or materials reinforced with glass or carbon fibers, natural stone, silicates, etc.);
The implant removable bridge (IRB) is made of any rigid, metallic or non-metallic material (such as, for example, metals-gold, titanium, chrome-cobalt, different forms of zirconium, porcelain, plastic/acrylic/polymeric materials, composite materials, glass and carbon, and/or materials reinforced with glass or carbon fibers, natural stone, silicates, etc., and combinations thereof). When the material of which the implant removable bridge (IRB) is a structural material, there is need to apply thereto a finishing layer mimicking the shape, size, color and texture of the natural teeth;
The super structure is made of any rigid, metallic or non-metallic material (such as, for example, metals- gold, titanium, chrome-cobalt, different forms of zirconium, porcelain, plastic/acrylic/polymeric materials, composite materials, and combinations thereof, glass and carbon, and/or materials reinforced with glass or carbon fibers, natural stone, silicates, etc.). as mentioned herein, the supper structure can be born out of a solid, one-piece, implant removable bridge (IRB), i.e. machined out of, or configured during molding of the removable bridge;
The implant removable bridge is a dental bridge i.e. follows the individual's anatomical parameters, and conforming with resident natural teeth or artificial teeth of the individual such as shape, texture, color etc. and is of substantially the same size of the individual's natural teeth, (however with substantially no real gaps therebetween, or such that fine gaps extend only at an upper portion between neighboring teeth);
The implant removable bridge is devoid of a skirt portion i.e. a gum mimicking portion (at times referred to as an ‘acrylic flange’) and is configured for riding over or extending in close proximity with the natural gum of the individual;
A narrow (i.e. short) transition strip (at times referred to as ‘scalloping strip’), is configured at least at a labial bottom face of the implant removable bridge (IRB), i.e. at a region configured to extend over or in proximity to the gum, said strip can be tinted and/or differently shaped/texturized/colored, in conformation with the gum of the individual. Such a strip is hereby defined as a scalloping gingival strip (SGS) and it mimics and merges with the individual's buccal gingival area in appearance and shape, i.e. as far as its scalloping shape, color and stippling thereof.
A bottom portion of the mini support bar (MSB), i.e. that portion extending in proximity to the gum of the individual, has a scalloping pattern, i.e. is shaped in conformity with anatomical shape of the individual's gum and teeth formed at the implant removable bridge, and does not show below the bottom of the implant removable bridge;
The super structure fully extends within the implant removable bridge (IRB) and is configured with a top surface and side walls extending therefrom; said top surface and side walls of the super structure are configured such that at least portions thereof bear in surface contact over corresponding top surfaces and side walls of the mini support bar (MSB). It is however appreciated that according to yet a configuration of the disclosure, only portions of side walls of the super structure bear in surface contact over respective side walls of the mini support bar (MSB), however contact between the implant removable bridge and the mini support bar provides substantially motion-free engagement, at high tolerance;
The scalloping pattern of the scalloping gingival strip coextends with the scalloping pattern of the implant removable bridge, and together said scalloping pattern matches and merges with the anatomical shape of the individual's gum;
The super structure of the implant removable bridge (IRB) and the mini support bar are configured such that their respective side walls are either parallel to the path of insertion (POI) or constitute an angle therewith (‘retraction angle’); said angle extending between about 0° and 30°. It is noted that the respective labial side wall and lingual side wall can be oriented differently (e.g. one being parallel to the POI and the other being inclined with respect thereto);
The mini support bar and the super structure can be configured with any cross-section, i.e. can be configured with corresponding straight or tapering side walls with respect to the path of insertion, and can be configured with flat (planer) top face or said top face can be arced (concave, convex);
The mini support bar and the super structure can be configured with different lateral projections corresponding grooves, for improved support of the implant removable bridge (IRB) over the mini support bar;
The locking arrangement comprises one or more locks configured for releasable locking engagement, at one or both of the implant removable bridge (IRB) and mini support bar, said locks can be of any design, such as, for example: retractable pin locks, ball-joint locks, magnet-based locks, swivel-type locks, locators, or any other type of locking mechanism;
The one or more locking mechanisms can be configured at the posterior end of the bridge system and/or at any intermediate portions thereof;
The one or more locking mechanisms can be configured at a lingual and/or labial face (side walls) of the mini support bar, or at a top face thereof;
The load applied through the implant removable bridge while biting is fully born by the mini support bar and directed to the fixtures (and further to the bone tissue). When retraction/extraction pin-type locks are used they substantially do not bear any loads (i.e. shear forces or compression forces are substantially eliminated); however, other types of locks such as ball and socket type locks configured on a top surface of the mini support bar can be configured to bear compression forces; it is noted that forces reside at the event of ball-type locks configured on labial or lingual surfaces of the mini support bar;
The mini support bar can be configured with locking portions for locking engagement with the implant removable bridge (IRB), at least one of said at least one locking portions is configured in register with a fixture supporting the mini support bar, whereby loads are directly applied to the respective fixture;
According to one example the one or more locks are a pin-type locks, each lock configured with a locking pin displaceable through either a rear face (lingual face) or a front face (labial face) of the implant removable bridge (IRB), between a locked position in which it arrests a locking bore configured at a locking portion of the mini support bar, (wherein the implant removable bridge (IRB) is prevented from displacement about a path of insertion thereof), and an un-locked position where it is disengaged from said locking portion (and whereby the implant removable bridge (IRB) may be removed along its path of insertion);
The locking portion can be configured at the positioning locations and/or at the beams of the mini support bar;
An ejection bore may extend across the mini support bar and implant removable bridge (and through the integrated super structure), coaxial with the axially displaceable locking pin, to assist in displacing the pin into its unlocked position
Surfaces of the super structure and corresponding surfaces of the mini support bar are machined (e.g. during a milling process or otherwise) at high tolerances, such that when said respective surface bare against one another they ensure tight fit between the super structure and the mini support bar, at a substantially motion-free snuggly fitting, however whilst preventing clamping therebetween so as to ensure easy and tool-free removal of the implant removable bridge from the mini support bar.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIGS. 1A and 1B are perspective labial and lingual views, respectively, of the assembled dental bridge system according to the present disclosed subject matter;

FIG. 1C is a section along line C-C in FIG. 1B;

FIG. 2A is an exploded isometric labial view of the dental bridge system of FIG. 1;

FIG. 2B is a section along line B-B in FIG. 2A;

FIG. 3A is a top view of a mini support bar (MSB) used dental bridge system according to the present disclosed subject matter, fixed to a jaw of an individual;

FIG. 3B is a lingual perspective view of FIG. 3A;

FIG. 3C is a labial perspective view of FIG. 3A;

FIG. 3D is a labial view of FIG. 3A;

FIG. 4A is a perspective labial view of an implant removable bridge (IRB) used with an implant removable bridge system according to the present disclosed subject matter;

FIG. 4B is a perspective lingual view of the dental bridge of FIG. 4A;

FIG. 4C is lingual bottom view of the dental bridge of FIG. 4A;

FIGS. 5A and 5B are local sections through a lock mechanism according to an example, at an unlocked and locked position, respectively.

### DETAILED DESCRIPTION OF EMBODIMENTS

Attention is directed to the annexed drawings illustrating an implant removable bridge (IRB) system in accordance with the disclosed subject matter and generally designated 10, the system comprising a personalized implant removable bridge (IRB) 14 configured for mounting over a mini support bar (MSB) 18.

The mini support bar 18 is generally shaped in correspondence with the implant removable bridge 14 however, in reduced scale, and as will be discussed hereinafter is configured for bearing the implant removable bridge at a substantially tolerance-free fashion. The mini support bar 18 is made of any rigid material e.g. metallic or non-metallic materials, such as, for example, metals (gold, titanium, chrome-cobalt, any form of zirconium, porcelain, etc.) or any plastic, acrylic or polymeric materials, composite materials and combinations thereof, or glass and carbon, and/or materials reinforced with glass or carbon fibers, natural stone, silicates, etc.

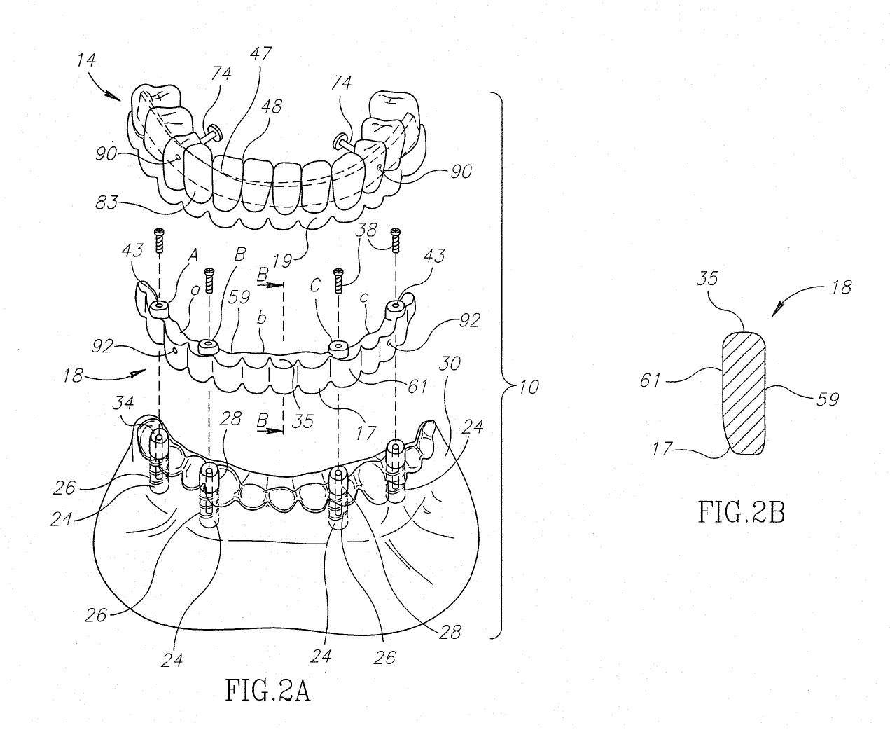

The mini support bar 18 is configured for fixedly securing to a jaw-bone of an individual (the mandibular jaw is represented in the figures by reference numeral 20) by several fixtures (four in the present example) designated 24, wherein each fixture in fact comprises a stud (implant) 26 screw fitted within the mandibular bone 20 in a fixed manner, with a head portion thereof 28 projecting from the gum 30. Typically, though not compulsory, one or more of the head portions 28 of the fixtures is fitted with an abutment 34 (FIG. 2) provided for adapting a proper seating fixture for the mini support bar (MSB) 18.

The mini support bar 18 is fixedly secured over the fixtures 24 (or abutments 34 where appropriate) by a plurality of fixation screws 38 extending through openings 43 at the top surface 35 of the mini support bar 18, whereby the mini support bar is fixedly secured over the fixtures 24 in a steady, motionless fashion.

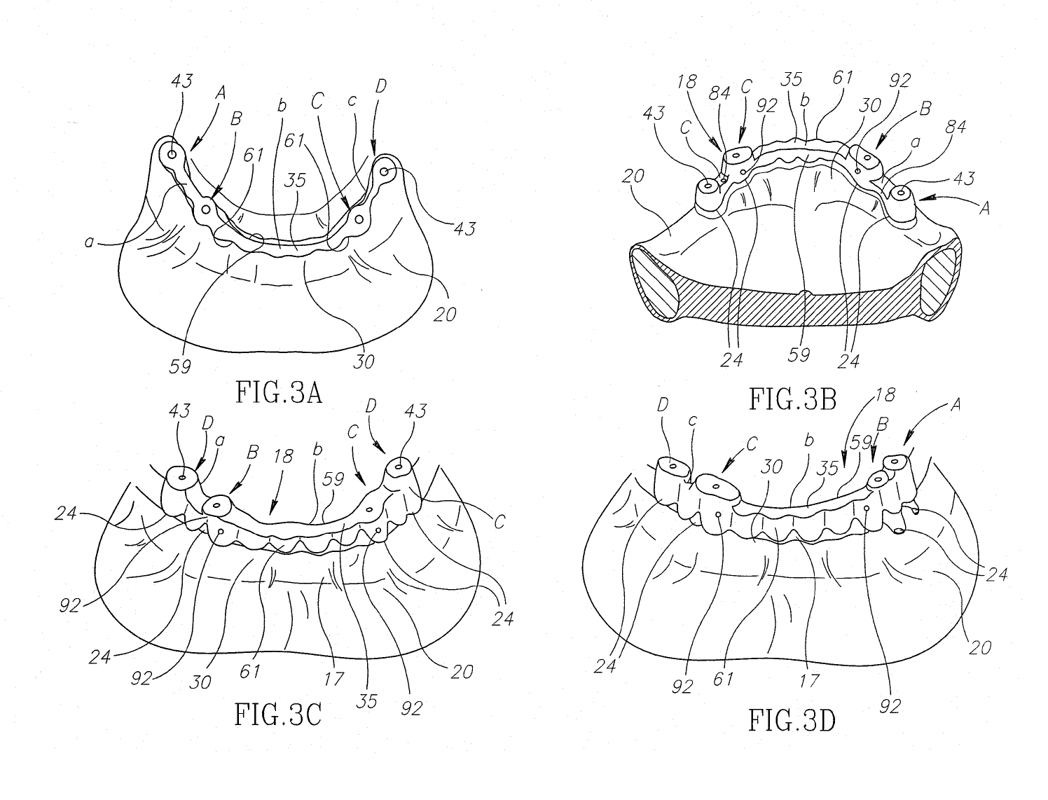

As can be seen in the drawings, best in FIGS. 2 and 3A-3D, the mini support bar is configured with widened locations identified in FIGS. 3A-3D as A, B, C, and D, said locations extending in correspondence with positioning locations of the mini support bar, namely extending over the fixtures 24. It is further noted that in the particular example, the neighboring positioning locations A, B, C, and D are connected by integral beam portions a, b and c respectively, said beam portions a, b and c being of reduced size, though constituting an integral and rigid mini support bar 18.

As will be illustrated hereinafter, the positioning locations A, B, C, and D are configured so as to extend at corresponding crown portions 47 of the implant removable bridge 14, namely within an artificial tooth of the implant removable bridge 14, rather than at a portion 48 between neighboring tooth, to thereby maintain a reduced and in-scale structure, not departing from the size and shape of the individual's natural teeth.

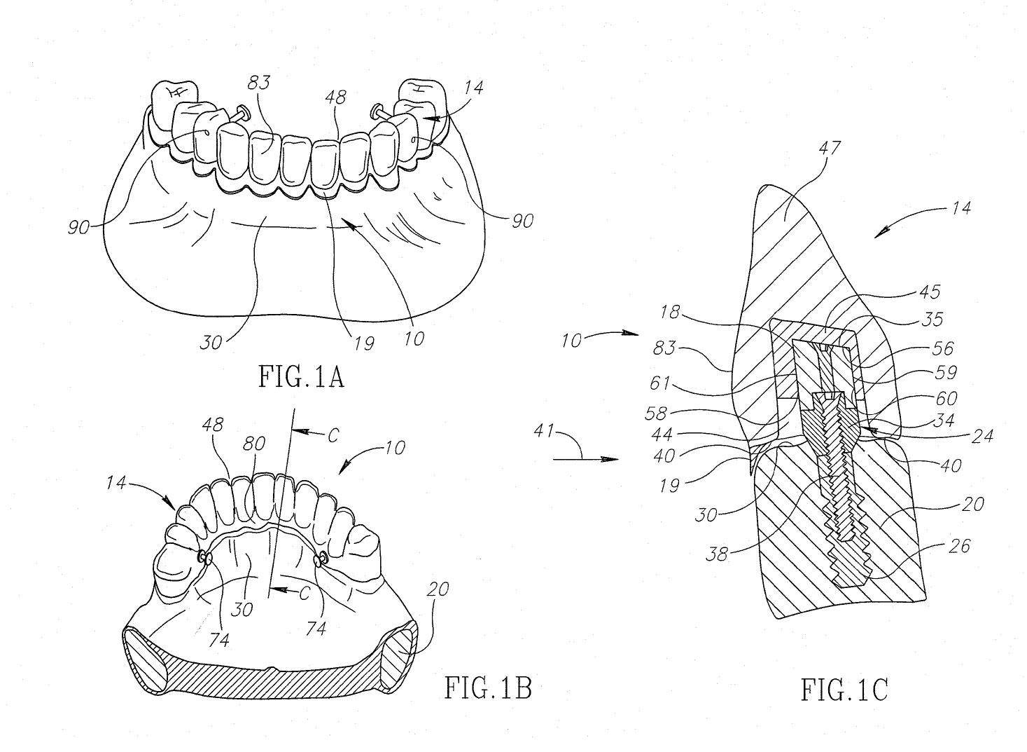

As can further be seen, best in FIGS. 2, 3C and 3D, a bottom portion 17 of the mini support bar (MSB) 18, i.e. that portion extending in proximity to the gum of the individual, is shaped in conformity with anatomical shape of the individual's gum and teeth formed at the implant removable bridge, so as not to show between the undulating pattern at the bottom of the implant removable bridge. It is thus seen that the bottom portion 17 has an undulating/scalloping pattern, i.e. is shaped in conformity with anatomical shape of the individual's gum, and conforming with the front bottom edge 19 of the implant removable bridge (IRB) 14 (FIGS. 1A, 1C, 2 and 4A).

As noted, best in FIGS. 2A and 2B, the mini support bar (MSB) 18 is configured with at least a scalloping labial surface 61 and a scalloping bottom surface 17 at least at a labial side thereof, imparting the mini support bar a bullet-like cross sectioned shape, best seen in FIG. 2B. This arrangement offers a mechanically stable structure, however having a small footprint and being light weight, also providing easy access into the gap established between the gum and the bottom surface 17 of the mini support bar 18.

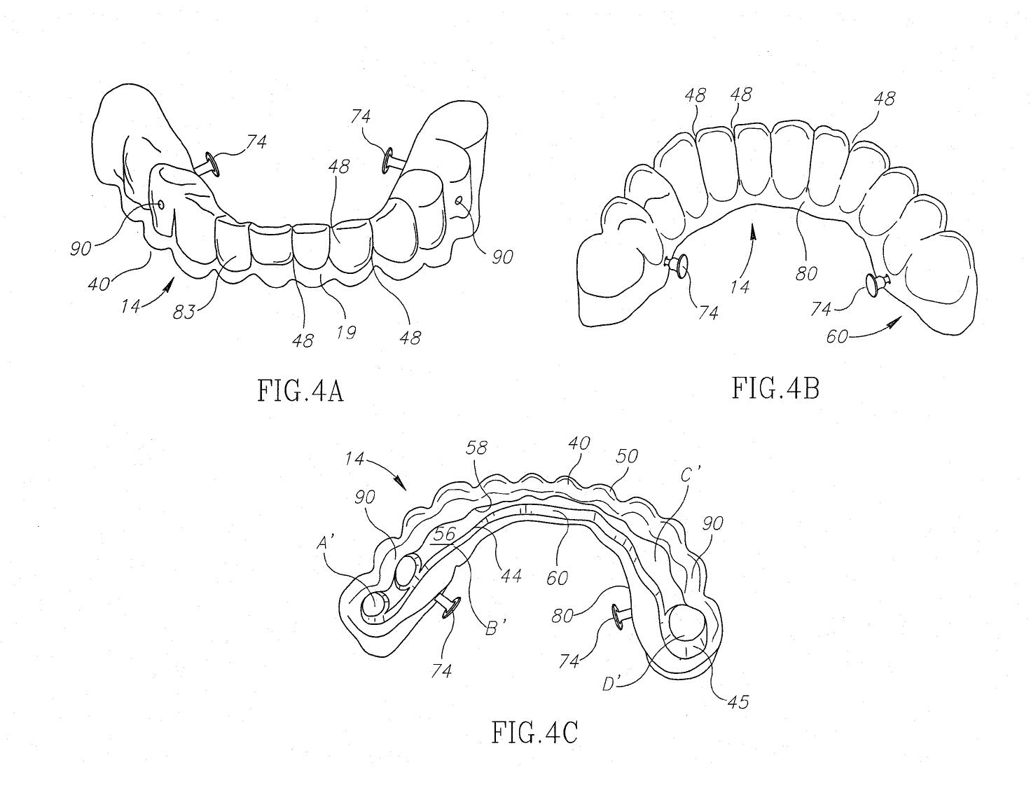

Turning now in particular to FIGS. 4A to 4C the implant removable bridge 14 is illustrated in more detail and as seen, it is configured for conforming with dental parameters of the individual i.e. being personalized as far as shape, size color, etc. The implant removable bridge 14 has a bottom surface 40 formed with an arch shaped receiving aperture 44 fixedly and integrated with a super structure 45 entirely embedded within a crown portion of the implant removable bridge 14.

The super structure 45 is made of any rigid, metallic or non-metallic material (such as, for example, metals- gold, titanium, chrome-cobalt, different forms of zirconium, porcelain, plastic/acrylic/polymeric materials, composite materials, and combinations thereof, glass and carbon, and/or materials reinforced with glass or carbon fibers, natural stone, silicates, etc.).

Whilst in the illustrated example the supper structure 45 fully extends within the implant removable bridge 14 and is fixedly embedded therewithin, namely being an element of material applied within the implant removable bridge 14 and integrated therein at a fixed fashion (e.g. by over molding the implant removable bridge, adhesion within the implant removable bridge, etc.), it is appreciated that the super structure can be configured as a receiving aperture extending and formed within the bottom face 40 of the implant removable bridge 14, i.e. born out of the implant removable bridge (e.g. by milling or during a molding process of the implant removable bridge).

When being a piece of material embedded within the implant removable bridge 14, the supper structure 45 can be made of any rigid, metallic or non-metallic material (such as, for example, metals—gold, titanium, chrome-cobalt, different forms of zirconium, porcelain, plastic/acrylic/polymeric materials, composite materials, and combinations thereof, glass and carbon, and/or materials reinforced with glass or carbon fibers, natural stone, silicates, etc.).

It is however appreciated that the supper structure 45 fully extends within the crown portion of the implant removable bridge 14.

The super structure 45 is shaped and sized so as to snugly fit, and bear over at least portions thereof, over the mini support bar (MSB) 18, at high tolerance, such that when applied thereover it is positioned with substantially no motion/movement therebetween and such that any loads applied to the implant removable bridge 14 (e.g. during biting) are borne by the mini support bar 18 and are transferred via the fixtures 24 to the jaw bone 20.

The implant removable bridge 14 is made of any rigid material e.g. metallic or non-metallic material (such as, for example, metals—gold, titanium, chrome-cobalt, any form of zirconium, porcelain, plastic, acrylic or polymeric materials, composite materials and combinations thereof, glass and carbon, and/or materials reinforced with glass or carbon fibers, etc.). It is appreciated that when the material of which the implant removable bridge 14 is a structural material, there is need to apply thereto a finishing layer mimicking the shape, size, color and texture of the nature teeth.

It is further noted that the implant removable bridge (IRB) 14 follows the individual's anatomical parameters and conforming with resident natural teeth or artificial teeth of the individual such as shape, texture, color, etc. and is of substantially the same size of the individual as natural teeth, however with substantially no real gaps between neighboring teeth or gaps being fine ones and extending only at upper portions of neighboring teeth 47, e.g. gaps designated 48. The shaping of the mini support bar (MSB) 18 is such so as to ensure that it does not show at a gap residing between the individual's gum and a neighboring edge of the implant removable bridge (IRB) 14.

As can further be seen, the bridge is substantially devoid of a skirt portion i.e., a gum mimicking portion and is in fact configured for riding over, or extending in close proximity, with the natural gum 30 of the individual. However, a narrow (i.e. short) transition strip 19 is provided at the bottom of the dental implant removable bridge 14, at the labial face thereof (pointed by arrowed line 41 in FIG. 1C), configured for extending over or in close proximity to the natural gum 30 of the individual, and being tinted in conformation with the gum of the individual. Such a strip is defined as a scalloping gingival strip (SGS) and it mimics and merges with the individual's buccal gingival area in appearance and shape, i.e. as far as its scalloping shape, color and stippling thereof.

Further appreciated, the scalloping pattern of the scalloping gingival strip (SGS) 19 of the implant removable bridge (IRB) 14 coextends with the scalloping pattern 17 (FIGS. 3C and 3D) of the mini support bar 18, and together said scalloping pattern matches and merges with the anatomical shape of the individual's gum.

It is appreciated that such a transition strip may be avoided, depending on anatomical parameters of the individual, and is provided for aesthetic reasons as well as to prevent functional problems such as distortion of the individual's face, not being able to chew, speech/phonetic distortion, spitting while talking, food debris accumulation under the bridge system, etc.

The super structure 45 within the receiving aperture 44 of the implant removable bridge 14 is configured with a bottom surface 56 and side walls, namely a labial side wall 58 and a lingual side wall 60, extending from the bottom surface 56. The bottom surface 56 and the side walls 58 and 60 are configured for bearing along at least substantial portions thereof or along their entire surface, over corresponding surfaces of the mini support bar 18.

In particular, the arrangement is such that the implant removable bridge 14, namely the super structure 45 (either fixedly integrated or formed within), snugly bears over at least portions of the mini support bar 18 at the positioning locations A, B, C, and D though, in accordance with a particular example the implant removable bridge 14 bears substantially also over the beam portions a, b, and c of the mini support bar 18.

It is thus noted that the super structure 45 of the implant removable bridge 14 is configured with widened portions at discrete locations identified at A′, B′, C′ and D′ corresponding in location with the widened positioning portions A, B, C, and D of the mini support bar 18, said portions configured for snugly fitting, at substantially high tolerance, over the mini support bar 18. It is thus typical that the widened locations A′, B′, C′, and D′ extend at the super structure 45 within the implant removable bridge 14, at locations of mimicking teeth 47 (crown portion), rather than at locations between the mimicking teeth (gaps 48) of the implant removable bridge 14.

The design of the mini support bar 18 and of the mating implant removable bridge 14, and in particular the super structure 45 (either integrated or integral with the mini support bar 18), is such that the tolerance therebetween is tight, at least at several positioning locations, so as to reduce, or substantially eliminate any tolerance and respective motion/movement of the implant removable bridge 14 over the mini support bar 18 and whereby forces applied to the implant removable bridge 14 are fully borne by the mini support bar 18 and are then transferred to the jaw-bone through the fixtures 24. However, in spite of the fit tolerance and snug fitting of the implant removable bridge 14 over the mini support bar 18, removal of the bridge is facilitated substantially without the need of any tools, along the path of insertion (POI).

The super structure 45 of the implant removable bridge 14, and the mini support bar 18 are configured such that their respective side walls (lingual and labial walls) are either parallel to the path of insertion (POI) or constitute an angle therewith (referred to as a ‘retraction angle’) said retraction angle extending between the range of about 0°-30°, with a preferred range being about 0°-20°, and even preferably in the range of about 0°-12°.

Furthermore, the super structure 45 of the mini support bar 18 and correspondingly the implant removable bridge 14, can be configured with different cross-sections to facilitate increase of surface contact therebetween and for that purpose, the mini support bar and bridge may be configured with different lateral projections and corresponding grooves, for improved support of the implant removable bridge 14 over the mini support bar 18.

The mini support bar 18 and the super structure 45 can be configured with any cross-section, i.e. can be configured with corresponding straight or tapering side walls with respect to the path of insertion, and can be configured with flat (planer) top face or said top face can be arced (concave, convex). The bottom surface 56 and side walls, namely a labial side wall 58 and a lingual side wall 60 of the super structure are configured such that at the assembled position at least portions thereof bear in surface contact over corresponding top surfaces 35 and lingual side wall 59 and labial side wall 61 of the mini support bar 18 (MSB).

It is however appreciated that according to yet a configuration of the disclosure, only portions of side walls of the super structure bear in surface contact over respective portions of side walls of the mini support bar (MSB), however contact between the implant removable bridge and the mini support bar provides substantially motion-free engagement, at high tolerance, i.e. with a small gap extending between a bottom surface 56 of the super structure 45 and a top surface 35 of the mini support bar 18. It is appreciated that contact between the respective contacting surfaces of the mini support bar 18 and the super structure 45 can be interrupted or continuous.

Respective surfaces of the super structure 45 and corresponding surfaces of the mini support bar 18 are machined (e.g. during a milling process or otherwise) at high tolerances, such that when said respective surface bare against one another they ensure tight fit between the super structure and the mini support bar, at a substantially motion-free snuggly fitting, however whilst preventing clamping therebetween so as to ensure easy and tool-free removal of the implant removable bridge from the mini support bar.

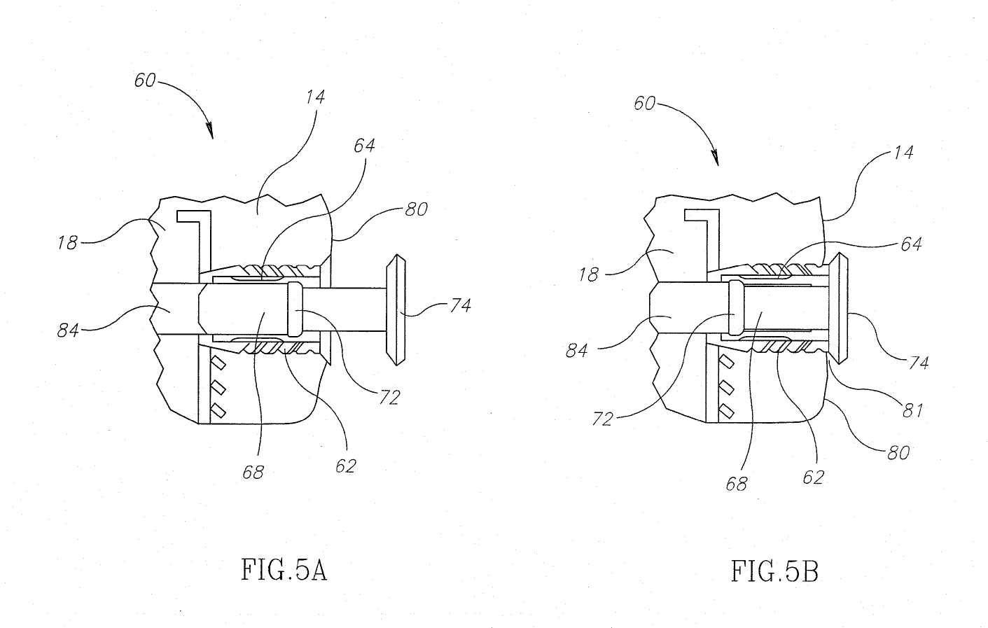

A locking arrangement is provided for releasable locking of the implant removable bridge 14 the mini support bar 18. In a particular example, the locking arrangement is a pin-type lock mechanism 60 discussed hereinafter in further detail with reference to FIGS. 5A and 5B. The lock 60 comprises a housing 62 rigidly embedded within the personalized implant removable bridge 14, wherein said housing comprises a sleeve 64 made of an elastomeric or ceramic material and furthermore, the lock 60 comprises a locking pin 68 formed with an annular displacement limiting ring 72, configured for snapping arresting by shoulders of the sleeve 64. The pin 68 is displaceable between a locked position (FIG. 5B) and an unlocked position (FIG. 5A). The locking pin 68 is fitted with a substantially flat head portion 74 which at the locked position extends in close proximity with the lingual surface 80 of the personalized implant removable bridge 14, thus causing irritation to the individual, and however facilitating retraction thereof e.g. by the individual's finger nail. If desired the lock can be inverted such that the head portion 74 extends at the labial face of the implant removable bridge 14.

For that purpose, a small interstice 81 (FIG. 5B) is typically configured between the inner surface of the head 74 and the lingual surface 80. The arrangement is such that the locking pin 68 is fitted for snugly fitting within the corresponding bore 84 configured in the respective mini support bar 18, however, in a fashion wherein substantially no loads are borne by the pin while at the locked position, also at the event of pressure applied by the bridge, e.g. during biting.

In some cases, the bridge is fitted with a through-going bore 90 extending also at the labial face 83, with a corresponding through-going locking bore formed in the mini support bar 18 and designated 92, where in case of distally extracting the locking pin 74, a sharp article may be inserted through the opening (e.g. a paper staple, and the like) to facilitate in pushing the locking pin 74 in the lingual direction, in its extracted, open position. However, such an opening on the labial surface 83 of the implant removable bridge 14 is minimal and hardly noticeable by the observer.

Whilst a particular locking arrangement, namely a pin-type lock has been disclosed in connection with FIGS. 5A and 5B, it is appreciated that different types of locks may be used instead, or in combination, e.g. ball-joint locks, magnet-base locks, swivel-type locks, locators, friction-type locks, ball and socket locks, etc.

It is further noted that the one or more locks are configured at or near the posterior ends of the implant removable bridge 14 though any suitable location may be used, depending on parameters of the individual. However, it is important to note that any loads applied through the implant removable bridge 14 while biting, are fully borne by the mini support bar 18 and directed through the fixtures 24 to the bone tissue 20, whilst the one or more locks 60 substantially do not bear any loads (no shear forces or compression forces, whereby the locks serve merely to prevent unintentional detachment of the implant removable bridge 14 from the mini support bar 18).

As mentioned above, the locks stand at the widened portions of the bridge system, namely extend in register with a fixture supporting the mini support bar. However, it is appreciated that the locking portions may be configured either at the positioning locations (designated A, B, C, and D) or at any other location along the beam portions a, b and c.

1. A removable dental implant bridge system configured for rigid detachable mounting of an implant removable bridge over a mini support bar, which in turn is configured for fixedly securing to the jaw bone of an individual, in a fashion facilitating fast and easy mounting yet fixedly supporting the implant removable bridge so as to obtain a sturdy and secure engagement to the mini support bar, and however suited for easy removal, wherein the mini support bar is substantially received with a teeth mimicking portion of the implant removable bridge and where the mini support bar is configured with scalloping at least at a labial face and a bottom face thereof.

2. A removable dental implant bridge system according to claim 1, wherein the implant removable bridge is configured with scalloping gingival strip mimicking and merging with the individual's buccal gingival area.

3. A removable dental implant bridge system according to claim 1, wherein a locking arrangement is provided for removably locking the implant removable bridge to the mini support bar, and comprising one or more locks of any one or more types.

4. A removable dental implant bridge system according to claim 1, wherein the mini support bar is shaped in reduced scale of the implant removable bridge.

5. A removable dental implant bridge system according to claim 1, wherein widened positioning locations extend along the mini support bar at locations corresponding with fixture arresting sites, said positioning locations extend at corresponding crown portions of the implant removable bridge.

6. A removable dental implant bridge system according to claim 5, wherein the mini support bar is configured with a plurality of positioning locations, and wherein neighboring positioning locations are connected by integral beams, said beams being of reduced size; and where the implant removable bridge is configured for tight tolerance fitting over at least positioning locations of the mini support bar.

7. A removable dental implant bridge system according to claim 1, wherein the implant removable bridge is devoid of a flanged skirt portion and further wherein at an assembled position the implant removable bridge is configured for riding over or extending in close proximity with the natural gum of the individual.

8. A removable dental implant bridge system according to claim 1, wherein a narrow transition scalloping gingival strip is configured at a labial bottom edge of the implant removable bridge.

9. A removable dental implant bridge system according to claim 1, wherein the scalloping pattern bottom portion of the mini support bar is shaped in conformity with anatomical shape of the individual's gum and teeth formed at the implant removable bridge, and does not to show between an undulating pattern at the bottom of the implant removable bridge.

10. A removable dental implant bridge system according to claim 1, wherein the super structure fully extends within the implant removable bridge and is configured with a bottom surface and side walls extending therefrom, wherein at the mounted position at least portions of the side walls of the super structure bear in surface contact over respective side walls of the mini support bar.

11. A removable dental implant bridge system according to claim 10, wherein at the mounted position at least portions of the bottom surface and portions of the side walls of the implant removable bridge bear in surface contact over corresponding top surfaces and side walls of the mini support bar.

12. A removable dental implant bridge system according to claim 8, wherein the scalloping pattern of the scalloping gingival strip coextends with the scalloping pattern of the implant removable bridge, and together said scalloping pattern matches and merges with anatomical shape of the individual's gum.

13. A removable dental implant bridge system according to claim 1, wherein the super structure of the implant removable bridge and the mini support bar are configured such that their respective side walls are either parallel to a path of insertion or extend at an angle of between about 0° and 30°.

14. A removable dental implant bridge system according to claim 3, wherein retraction/extraction pin-type locks are used such that loads applied through the implant removable bridge while biting are fully born by the mini support bar and directed to the fixtures, and wherein the locks substantially do not bear any shear forces.

15. A removable dental implant bridge system according to claim 3, wherein the mini support bar is configured with locking portions for locking engagement with the implant removable bridge, at least one of said at least one locking portions is configured in register with a fixture supporting the mini support bar, whereby loads are directly applied to the respective fixture.

16. A removable dental implant bridge system according to claim 3, wherein the locking portion can be configured at the positioning locations and/or at the beams of the mini support bar.

17. A removable dental implant bridge system according to claim 3, wherein an ejection bore extends across the mini support bar and implant removable bridge and in register through the integrated super structure, coaxial with the axially displaceable locking pin, to assist in displacing the pin into its unlocked position.

18. A removable dental implant bridge system according to claim 1, wherein a narrow gap extends between the scalloping bottom surface of the mini support bar and the gum.

19. A removable dental implant bridge system comprising a mini support bar for fixedly securing over head portions of fixtures secured to a jaw bone of an individual, said mini support bar sized for fitting within the crown portion of an implant removable bridge, said mini support bar configured with scalloping at least at a labial face and a bottom face thereof; an implant removable bridge generally conforming with dental parameters of an individual, configured with a super structure fully extending within the implant removable bridge, said super structure shaped and configured so as to snugly fit, at high tolerance, over at least portions of the mini support bar; and a locking arrangement for removably locking the implant removable bridge to said mini support bar, and comprising one or more locks for detachable locking of the implant removable bridge to the mini support bar.

20. An implant removable bridge generally conforming with dental parameters of an individual, having a bottom surface formed with a receiving aperture, configured with a super structure fully extending within a crown portion of the implant removable bridge, said super structure shaped and configured so as to snugly fit, at high tolerance, over a mini support bar fixedly secured to a jawbone of the individual, however configured for easy and readily removal, said super structure configured with a scalloping pattern at least at a labial face thereof, conforming with at least respective portions of the mini support bar.

21. A mini support bar for fixedly securing to a jaw bone of an individual directly over fixtures or indirectly over abetments, said mini support bar shaped and configured for snugly fit, at high tolerance, within a super structure fully extending within a crown portion of an implant removable bridge, and wherein the mini support bar is configured with scalloping at least at a labial face and a bottom face thereof.

22. A method for applying an individual with an implant removable bridge at a readily removably yet secured fashion, the method comprises the steps of fixing several fixtures into a jawbone of the individual, each having an implant body fixedly received within the jawbone and a head portion projecting from the gum; obtaining a mini support bar sized for fitting within the crown portion of an implant removable bridge, wherein the mini support bar is configured with scalloping at least at a labial face and a bottom face thereof; fixing the mini support bar over the head portion of the fixtures or over abutments secured to the fixtures; obtaining an implant removable bridge generally conforming with dental parameters of the individual, having a bottom surface with a receiving aperture configured with a super structure fully extending within a crown portion of the implant removable bridge, said super structure shaped and configured so as to snugly fit, at high tolerance, over the mini support bar; placing the implant removable bridge over the mini support bar such that the super structure snugly bears, at high tolerance over at least portions of the mini support bar. and wherein the mini support bar is fully received within a teeth mimicking portion of an implant removable bridge.
